(19) United States
(12) Patent Application Publication
(10) Pub. No.: US 2024/0285451 A1
(43) Pub. Date: Aug. 29, 2024

(54) PERSONAL MOBILITY DEVICE SYSTEM AND CONTROL METHOD THEREOF

(71) Applicant: ELECTRONICS AND TELECOMMUNICATIONS RESEARCH INSTITUTE, Daejeon (KR)

(72) Inventor: Youngjin KWON, Daejeon (KR)

(73) Assignee: ELECTRONICS AND TELECOMMUNICATIONS RESEARCH INSTITUTE, Daejeon (KR)

(21) Appl. No.: 18/401,069

(22) Filed: Dec. 29, 2023

(30) Foreign Application Priority Data
Feb. 27, 2023 (KR) 10-2023-0025817

(51) Int. Cl. A61G 5/04

(52) U.S. Cl. CPC A61G 5/047; A61G 5/045

(57) ABSTRACT

Proposed are a personal mobility device system and a control method of a personal mobility device system. The personal mobility device system includes a boarding body having a seat that a user is capable of sitting on, and includes a moving body which is coupled to the boarding body and which has a driving force based on an electric power.

### CROSS REFERENCE TO RELATED APPLICATION

The present application claims priority to Korean Patent Application No. 10-2023-0025817, filed Feb. 27, 2023, the entire contents of which are incorporated herein for all purposes by this reference.

### BACKGROUND OF THE INVENTION

### Field of the Invention

The present disclosure relates to a personal mobility device system and a control method thereof. More particularly, the present disclosure relates to a personal mobility device electrification system and a control method thereof.

### Description of the Related Art

A personal mobility device that a user is capable of boarding and sitting on is intended to provide a convenient mobility service for the user. Existing personal mobility devices that a user is capable of sitting on have been mainly manufactured in the form of a wheelchair, but the devices have been developed as a furniture type device considering sitting of the general public. In the furniture type device, in relation to a shape of a boarding body that a user is capable of boarding and sitting on, a design of the shape of the boarding body required by the user may vary according to a place where a service providing the use of the personal mobility device is performed. However, as in the conventional technology, when the personal mobility device system is designed in a single configuration or a single structure, there is a limitation in satisfying a requirement of diversity in the design related to the shape of the boarding body.

### SUMMARY OF THE INVENTION

Accordingly, the present disclosure has been made keeping in mind the above problems occurring in the related art, and an objective of the present disclosure is to provide a boarding body on which a user sits and a moving body providing a driving force, the boarding body and the moving body being separated into separate structures or separate modules so that the boarding body is capable of being replaced and used according to the needs of a user.

A purpose of the objective is to provide an advantage of satisfying the user's demand by configuring the boarding body such that various designs of the boarding body are capable of being provided according to a place where a service providing the use of a personal mobility device is performed.

According to an aspect of the present disclosure, there may be provided a personal mobility device system, the personal mobility device system including: a boarding body having a seat on which a user is capable of sitting; and a moving body coupled to the boarding body, the moving body having a driving force based on an electric power.

According to another aspect of the present disclosure, there may be provided a control method of a personal mobility device system, the control method including: a calling process in which a user calls a moving body by using a remote controller mounted on a boarding body; a matching process in which a control server matches the moving body in response to a call from the remote controller; and a setting process in which the moving body called and positioned adjacent to the boarding body identifies an ID mounted on the boarding body and sets driving.

In providing a service such as indoor autonomous driving, requirements of a wheelchair or other specific types of personal mobility devices may significantly vary according to an on-site situation of a place where the service is provided and according to an industry of a person providing a personal mobility device system, a user, or a consumer.

For example, the form of a personal mobility device required according to an industry of a person providing the personal mobility device system such as an airport lounge, a hospital, a shopping mall, or an exhibition center may be different. In addition, even in the same industry, the shape of a boarding body is required to be differentiated by the need of a person requiring the personal mobility device system.

According to the configuration of the present disclosure, since the boarding body having a variety of furniture shape is configured such that a modified boarding body to which a conversion kit is coupled or a dedicated type boarding body in which a docking interface according to a system standard is mounted is coupled to the moving body providing the autonomous driving service, the indoor autonomous driving service according to the need of an on-site situation of a place where the service is provided may be provided. There is an advantage that ordinary people do not have a sense of foreignness in using the personal mobility device service since the boarding body does not have the shape of a traditional wheelchair and utilizes functions of the furniture. In addition, due to the detachable structure of the moving body, when the personal mobility device service is required, the autonomous driving moving body is called upon request rather than all of the boarding bodies are provided as boarding bodies capable of performing autonomous driving, so that the method of providing the personal mobility device service may have a business effect of providing an efficient service in a small quantity.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a conceptual view illustrating a boarding body and a moving body according to an embodiment of the present disclosure;

FIG. 2 is a view illustrating a detailed structure of the boarding body and the moving body according to an embodiment of the present disclosure;

FIG. 3 is a view illustrating examples of dockers for coupling the boarding body and the moving body to each other according to an embodiment of the present disclosure;

FIG. 4 is a view illustrating a conversion kit according to an embodiment of the present disclosure;

FIG. 5 is a view illustrating seats of modified boarding bodies in various shapes according to an embodiment of the present disclosure;

FIG. 6 is a view illustrating the conversion kits in various shapes according to an embodiment of the present disclosure;

FIG. 7 is a view illustrating calling of the moving body and matching of the boarding body according to an embodiment of the present disclosure; and

FIG. 8 is a view illustrating an ID for identifying the boarding body according to an embodiment of the present disclosure.

### DETAILED DESCRIPTION OF THE INVENTION

The above and other objectives, features, and advantages of the present disclosure will be more clearly understood from the embodiments below when taken in conjunction with the accompanying drawings. However, the present disclosure is not limited to the embodiments described herein and may be embodied in other forms. The embodiments described herein are presented to form a complete disclosure of the present disclosure and to help those of ordinary skill in the art best understand the disclosure.

Throughout the accompanying drawings, similar reference numerals will be used to describe similar components. In the drawings, the thicknesses of certain lines, layers, components, elements, or features may be exaggerated for clarity. Terms “first”, “second”, etc. can be used to describe various elements, but the elements are not to be construed as being limited to the terms. The terms are used only for the purpose of distinguishing one constituent element from another constituent element. For example, a first element may be termed a second element, and a second element may be termed a first element, without departing from the scope of the present disclosure. Singular expressions include plural expressions unless the context clearly indicates otherwise.

In the present specification, it is to be understood that terms such as “including”, “having”, etc. are intended to indicate the existence of the features, numbers, steps, actions, elements, components, or combinations thereof disclosed in the specification, and are not intended to preclude the possibility that one or more other features, numbers, steps, actions, elements, components, or combinations thereof may exist or may be added. In addition, it will also be understood that when a layer, a film, a region, a plate, etc. is referred to as being “on” or “above” another part, it can be “directly on” the other part, or intervening layers may also be present. On the contrary, it will also be understood that when a layer, a film, a region, a plate, etc. is referred to as being “under” or “below” another part, it can be “directly under” the other part, or intervening layers may also be present.

FIG. 1 is a conceptual view illustrating a boarding body and a moving body according to an embodiment of the present disclosure.

Referring to FIG. 1, a personal mobility device system according to an embodiment of the present disclosure may include a boarding body 210, and a moving body 110. The boarding body 210 is a dedicated type boarding body 210 in which a docking interface according to a system standard is mounted, and may have a seat 211 where a user is capable of sitting thereon. The moving body 110 may constitute the personal mobility device system by being combined with the boarding body 210. The moving body 110 may have a driving force based on an electric power.

As can be seen in FIG. 1, the moving body 110 according to an embodiment of the present disclosure may be classified as a moving body 130 of a first embodiment and a moving body 140 of a second embodiment. The moving body 130 of the first embodiment may be docked with a lower end portion of the boarding body 210, and the moving body 140 of the second embodiment may be docked with an upper end portion and the lower end portion of the boarding body 210.

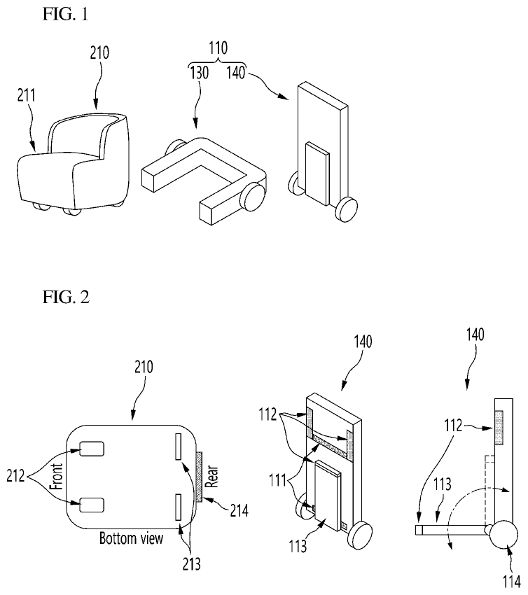

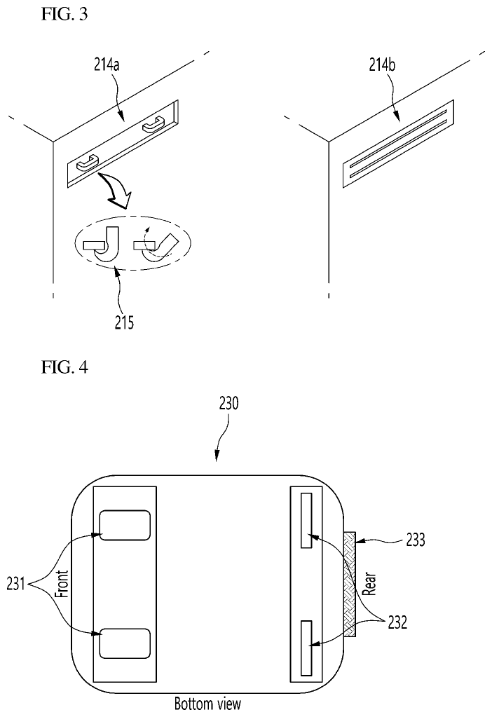

FIG. 2 is a view illustrating a detailed structure of the boarding body and the moving body according to an embodiment of the present disclosure, and FIG. 3 is a view illustrating examples of a docker for coupling the boarding body and the moving body according to an embodiment of the present disclosure.

Referring to a bottom view of the boarding body 210 illustrated in FIG. 2, the boarding body 210 may include a wheel 212, a stopper 213, and a docker 214. The wheel 212 may be a configuration which is mounted on a front side of a bottom of the boarding body 210 and which is configured to be rotated when the boarding body 210 is moved. The stopper 213 may be mounted on a rear side of the bottom of the boarding body 210, and may be a portion used for performing a stop operation while the boarding body 210 is moved by the wheel 212. The docker 214 may be mounted for coupling the boarding body 210 to the moving body 110. A mounting position of the docker 214 may be a position where the boarding body 210 and the moving body 110 are coupled to each other.

Referring to FIG. 3, as illustrated in a left side in FIG. 3, a docker 214a mounted on the boarding body 210 may be engaged with a clasp 215 mounted on the moving body 110. At this time, as illustrated in FIG. 3, the clasp 215 may be formed in a hook shape, and the docker 214a may include a ring on which the clasp 215 having the hook shape is capable of being hung and supported. Alternatively, as illustrated in a right side in FIG. 3, a docker 214b mounted on the boarding body 210 may have a locking structure in the form of an electromagnet. In this case, by mounting a small lifter (a motor), a function in which a rear portion of the boarding body 210 is automatically lifted may be provided.

Again, referring to the moving body 140 illustrated in FIG. 2, the moving body 140 may include a docker 111, a driving sensor 112, a support plate 113, and a wheel 114. The docker 111 may be mounted on a position to which the boarding body 210 is coupled so that the docker 111 is coupled to the moving body 210. Specifically, the docker 111 may be mounted on the position to which the boarding body 210 is coupled so that the docker is coupled to the docker 214 mounted on the boarding body 210. The driving sensor 112 may be mounted on a front side of the moving body 140 such that the moving body 140 is capable of being driven autonomously. The support plate 113 may be mounted on a lower end of the moving body 140, and may have a structure in which the support plate 113 is capable of being folded up and down. The wheel 114 may be mounted on the bottom of the moving body 140, and may provide a driving force when the moving body 140 is moved.

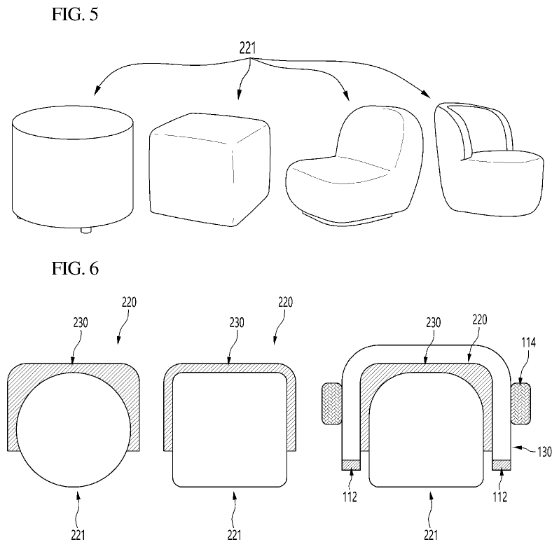

FIG. 4 is a view illustrating a conversion kit according to an embodiment of the present disclosure.

Referring to the bottom view of a conversion kit 230 illustrated in FIG. 4, the conversion kit 230 may include a wheel 231, a stopper 232, and a docker 233. The wheel 231 may be a configuration which is mounted on a front side of a bottom of the conversion kit 230 and which is configured to be rotated when the conversion kit 230 is moved. The stopper 232 may be mounted on a rear side of the bottom of the conversion kit 230, and may be a portion used for performing a stop operation while the conversion kit 230 is moved by the wheel 231. The docker 233 may be mounted for coupling the conversion kit 230 to the moving body 110. A mounting position of the docker 233 may be a position where the conversion kit 230 and the moving body 110 are coupled to each other.

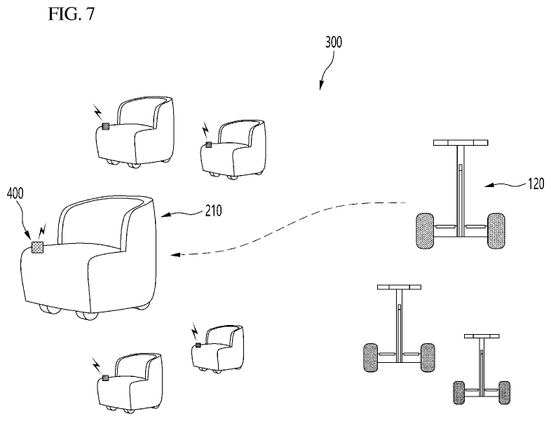

FIG. 5 is a view illustrating seats of modified boarding bodies in various forms according to an embodiment of the present disclosure, and FIG. 6 is a view illustrating the conversion kits in various forms according to an embodiment of the present disclosure.

Referring to FIG. 5, each seat 221 of the modified boarding body according to an embodiment of the present disclosure may be a furniture of various types. Specifically, an external appearance of each seat 221 may have various shapes such as a cylindrical shape, a cubic shape, an L shape, and so on.

Referring to FIG. 6, the conversion kit 230 according to an embodiment of the present disclosure may be formed in various shapes. As illustrated in FIG. 5, the conversion kit 230 may be formed in corresponding shapes such that the conversion kit 230 is coupled to the seats 221 of the modified boarding body 220, the seats 221 having various shapes.

Referring to FIG. 5 again, by providing the conversion kit 230 having the shapes corresponding to the seats 221 having the various shapes, the conversion kit 230 is capable of being coupled to the same moving body 130 regardless of the shape of the seat 221.

FIG. 7 is a view illustrating calling of the moving body and matching of the boarding body according to an embodiment of the present disclosure.

Referring to FIG. 7, the user may call the moving body 120 in order to move the boarding body 210 after using the boarding body 210 as a chair. To this end, the personal mobility device system according to an embodiment of the present disclosure may further include a control server 300 and a remote controller 400.

The remote controller 400 may provide a call-related function (reservation and cancellation) and an emergency stop function or a manual control function. Such a remote controller 400 may be provided in the form of an individual wireless terminal, or may be provided in the form of an application or a program installed in the user's terminal such as a smartphone and may provide a service. Such a service may include functions such as a call-related movement reservation function or cancellation function, a destination search function, an emergency stop function, or a manual control function.

The control server 300 may be matched according to a position of the calling boarding body 210 and a distance of the called moving body 120. In addition, the control server 300 may determine a state of the called moving body 120. For example, the control server 300 may determine a state of the called moving body 120 on the basis of a battery state or durability of the moving body 120.

Furthermore, according to an on-site situation, all the moving bodies 120 may be configured such that the coupling of the moving body 120 may be released remotely or may perform priority control in an emergency situation.

In addition, the moving body 120 may perform a path control according to an emergency situation of the user, and may notify the emergency situation to a surrounding space of the moving body 120 by an identifiable sound or light.

As described in relation to FIG. 5 and FIG. 6, the seat 221 of the modified boarding body 220 may have various shapes. Therefore, according to the shape of the seat 221 of the modified boarding body 220, a restriction may occur on the utilization of the driving sensor of the moving body, and a limitation may be required on an acceleration and deceleration control according to the shape of the seat 221 of the modified boarding body 220 in order to provide a safe movement.

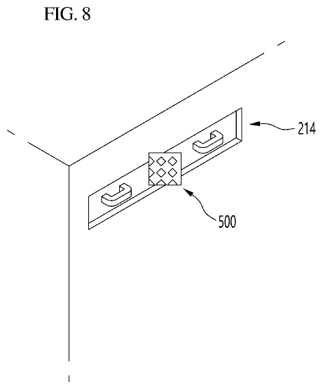

FIG. 8 is a view illustrating an ID for identifying the boarding body according to an embodiment of the present disclosure.

Referring to FIG. 8, the boarding body 210 may include an ID 500 positioned adjacent to the docker 214. The ID 500 may be used for identifying the boarding body 210 when the boarding body 210 is docked with the moving body 110. Through this identification, the driving according to the shape of the boarding body 210 to which the moving body 110 is coupled may be automatically set.

The ID 500 for identification may be configured as a QR code recognized by a camera, an ID read by contact, or an ID having a Radio-Frequency Identification (RFID) function.

Structural information of the boarding body 210 may include contents such as a weight, a volume, a shape, and a maximum safety speed.

What is claimed is:

1. A personal mobility device system comprising:
a boarding body having a seat that a user is capable of sitting on; and
a moving body coupled to the boarding body, the moving body having a driving force based on electric power.

2. The personal mobility device system of claim 1, wherein the boarding body is a dedicated type boarding body in which a docking interface according to a system standard is mounted.

3. The personal mobility device system of claim 2, wherein the dedicated type boarding body comprises a seat functioning as a chair, a wheel and a stopper that are mounted on a bottom of the dedicated type boarding body, and a docker mounted on a position where the dedicated type boarding body and the moving body are coupled to each other so that the docker is coupled to the moving body.

4. The personal mobility device system of claim 3, wherein the docker is configured to be fastened to a clasp, the clasp is formed in a hook shape, and the docker comprises a ring on which the clasp having the hook shape is capable of being hung and supported.

5. The personal mobility device system of claim 3, wherein the docker has a locking structure in a form of an electromagnet.

6. The personal mobility device system of claim 1, wherein the boarding body is a modified boarding body comprising a conversion kit that is coupled to the seat.

7. The personal mobility device system of claim 6, wherein the conversion kit comprises a wheel and a stopper that are mounted on a bottom of the conversion kit, and comprises a docker mounted on position where the conversion kit and the moving body are coupled to each other so that the docker is coupled to the moving body.

8. The personal mobility device system of claim 1, wherein the moving body comprises a docker mounted on a position where the moving body and the boarding body are coupled to each other so that the docker is coupled to the boarding body, a driving sensor configured to enable autonomous driving, a support plate formed in a foldable structure, and a wheel mounted on a bottom of the moving body.

9. The personal mobility device system of claim 1, further comprising a control server and a remote controller, the control server and the remote controller being configured to communicate with the moving body and to call the moving body to the boarding body.

10. The personal mobility device system of claim 9, wherein the boarding body further comprises an ID, the ID being configured to be identified by the moving body when the moving body is docked with the boarding body.

11. A control method of a personal mobility device system, the control method comprising:
a calling process in which a user calls a moving body by using a remote controller mounted on a boarding body;
a matching process in which a control server matches the moving body in response to a call from the remote controller; and
a setting process in which the moving body called and positioned adjacent to the boarding body identifies an ID mounted on the boarding body and sets driving.
